(19) United States
(12) Patent Application Publication
(10) Pub. No.: US 2021/0007454 A1
(43) Pub. Date: Jan. 14, 2021

(54) CELLULAR PHONE CARRIER CAP

(71) Applicant: Gary Joseph, Philadelphia, PA (US)

(72) Inventor: Gary Joseph, Philadelphia, PA (US)

(21) Appl. No.: 16/689,248

(22) Filed: Nov. 20, 2019

Related U.S. Application Data
(60) Provisional application No. 62/871,888, filed on Jul. 9, 2019.

(51) Int. Cl. A45C 13/02; H04B 1/3888; A45C 11/00; A45C 13/00

(52) U.S. Cl. CPC A45C 13/02; H04B 1/3888; A45C 2011/002; A45C 13/005; A45C 11/00

(57) ABSTRACT

A cell phone case/accessory that provides a storage compartment for containing articles, such as a reusable bag. The cell phone case/accessory has a carrier cap that houses a reusable bag, which improves on the reusable bag industry. With a reusable bag that is always connected to the consumers cell phone, that consumer will always have a bag in his or her possession when they enter a store, eliminating the need for the consumer to pre-plan a shopping trip or remember to carry a separate reusable bag.

### CROSS-REFERENCE TO RELATED APPLICATION

This application claims the benefit of priority of U.S. provisional application No. 62/871,888, filed Jul. 9, 2019, the contents of which are herein incorporated by reference.

### BACKGROUND OF THE INVENTION

The present invention relates to cellular phone cases, and more particularly to cellular phone cases with storage compartments.

There is a problem in the world with litter. Single-use plastic bags are one of the leading contributors to the litter crisis. The average American family takes home almost 1,500 plastic shopping bags a year. At least 267 different species have been affected by plastic bag pollution in the ocean. 100,000 marine animals are killed by plastic bags annually. And it takes 500 (or more) years for a plastic bag to degrade in a landfill.

As a result of all of this pollution, cities and states across America (and around the world) are beginning to ban the use of single-use bags in their stores leaving the consumer with little options.

The problem with other reusable bags, and there are countless, is that they are not part of the cell phone case. My research has shown that a consumer's quick stop into a convenience store, drug store, hardware store, etc., is not intended for a multiple-item purchase where they will need a bag. Therefore, the consumer does not bring a reusable bag into a store such as these. Consequently, they will be without a reusable bag when making these purchases.

My research indicates that, in our ever connected society, consumers are rarely without their cellular phone and will typically equip their cellular phone with a protective case.

As can be seen, there is a need for improved apparatus and methods for providing ready access to a reusable bag.

### SUMMARY OF THE INVENTION

In one aspect of the present invention, a carrier cap for a cellular phone device is disclosed. The carrier cap includes a main body having at least one sidewall defining an interior cavity. The main body is dimensioned to be received on one or more of a back surface of a cellular phone device or a case for a cellular phone device. An opening to the interior cavity is defined along a side of the main body. A closure is hingedly attached to the main body. The closure operable between a closed position covering the opening, and an open position providing access to the interior cavity via the opening.

In some embodiments, a plurality of hinge elements are defined along an edge of a front sidewall, along the opening to the interior cavity. A plurality of cooperating hinge elements are defined along a top end of the closure. The plurality of hinge elements and the plurality of cooperating hinge elements are joined in a snap fit configuration.

In other embodiments the carrier cap includes a release tab protruding from an edge of the closure along an edge of the closure opposite the cooperating hinge elements. The release tab is operable to release the closure from the closed position.

In other embodiments, a latch tab protrudes from an edge surface of the main body opposite the plurality of hinge elements. Alternatively, a latch tab is formed as a recess in an edge surface of the main body, opposite the plurality of hinge elements.

In other embodiments, the interior cavity is dimensioned to receive a folded reusable bag and a folded reusable bag may be received within the interior cavity.

In yet other embodiments, an adhesive layer formed on an outer surface of the back sidewall.

In other aspects of the invention, a cellular phone case with a carrier cap is disclosed. The cellular phone case has a body dimensioned to receive a cellular phone device, with the cellular phone case having a back surface. A carrier cap main body has at least one sidewall defining an interior cavity. The carrier cap main body is dimensioned to be received on the back surface of the cellular phone case. An opening to the interior cavity is defined along a side of the carrier cap main body. A closure is hingedly attached to the carrier cap main body. The closure is operable between a closed position covering the opening, and an open position providing access to the interior cavity via the opening.

In some embodiments, a plurality of hinge elements are defined along an edge of a front sidewall of the carrier cap main body, along the opening to the interior cavity. A plurality of cooperating hinge elements are defined along a top end of the closure. The plurality of hinge elements and the plurality of cooperating hinge elements are joined in a snap fit configuration.

In other embodiments, a release tab protrudes from an edge of the closure along an edge of the closure opposite the cooperating hinge elements. The release tab is operable to release the closure from the closed position.

In other embodiments, a latch tab protrudes from an edge surface of the carrier cap main body opposite the plurality of hinge elements. Alternatively, the latch tab may be formed as a recess in an edge surface of the carrier cap main body, opposite the plurality of hinge elements.

In a preferred embodiment, the interior cavity is dimensioned to receive a folded reusable bag. The folded reusable bag, is received within the interior cavity.

In other embodiments, an adhesive layer joins the carrier cap main body to the cellular phone case.

In yet other embodiments, the carrier cap main body is integrally formed with the cellular phone case.

These and other features, aspects and advantages of the present invention will become better understood with reference to the following drawings, description and claims.

### BRIEF DESCRIPTION OF THE DRAWINGS

FIG. 1 is a perspective view of the cellular phone carrier cap in a exploded configuration;

FIG. 2 is a perspective view of the cellular phone carrier cap in a exploded configuration while mounted to a cellular phone case;

FIG. 3 is a side elevation view of the cellular phone carrier cap;

FIG. 4 is a top plan view of the cellular phone carrier cap;

FIG. 5 is a right side elevation view of the cellular phone carrier cap;

FIG. 6 is a front view of the closure;

FIG. 7 is a cross-section view of the cellular phone carrier cap; and

FIG. 8 is a perspective view of a bag exploded away from the cellular phone carrier cap.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a cellular phone carrier cap with a compartment which may be utilized to house a reusable bag. The cellular phone carrier cap of the present invention will help eliminate the need for a consumer to take a single-use bag from a merchant, if the merchant is even allowed to provide that single-bag. Most people in 2019 carry their cell phones with them everywhere. So, by having a cell phone case/accessory that houses the reusable bag, the consumer will always have a bag on them.

Currently, there is no cell phone case that houses articles, such as a reusable bag. As will be appreciated a reusable bag only works when the consumer intentionally brings that bag into a store with them. The only option for a consumer today is to remember to purposely bring a separate, reusable bag into a store with them. With the present invention, the reusable bag is part of the cell phone case and a consumer will generally have his or her cell phone in their possession as they enter a store.

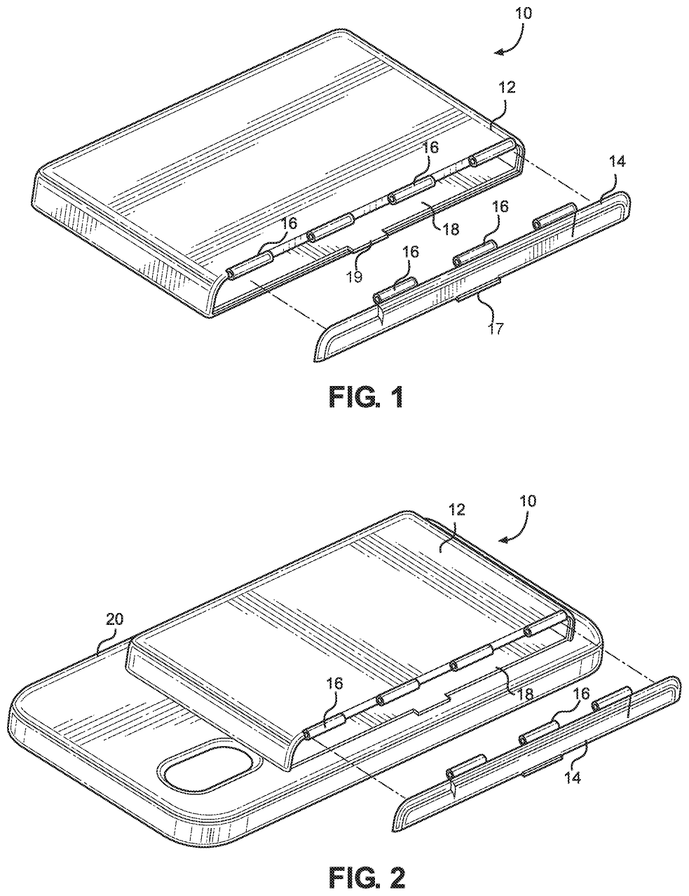

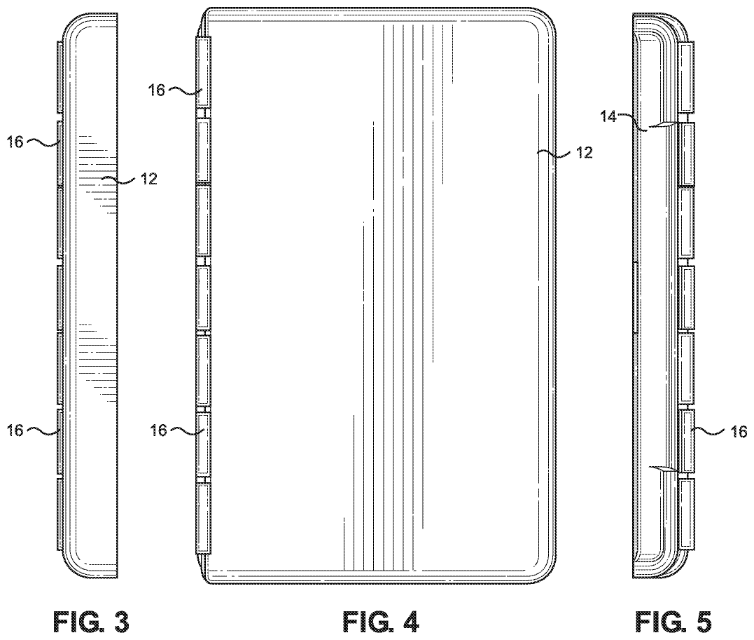

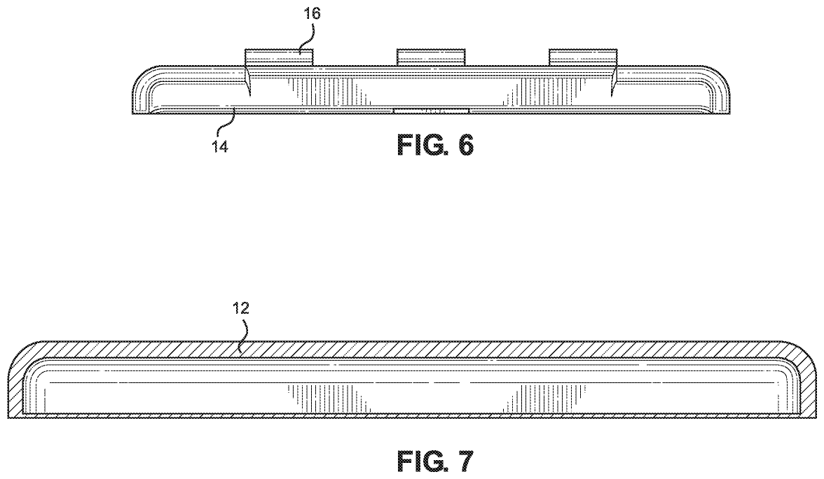

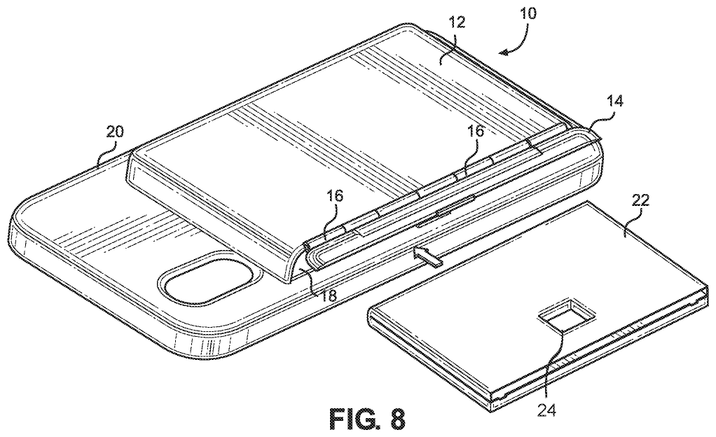

As seen in reference to the drawings of FIGS. 1-8, non-limiting embodiments of cellular phone carrier cap according to aspects the present invention may include the following elements: a carrier cap 10 for a cell phone case or protective shield 20. The carrier compartment 10 includes a main body 12 having a plurality of sidewalls defining an interior chamber 18. The plurality of sidewalls include a front wall and a rear wall. The cellular phone carrier cap 10 may be attached to the body of a cellular phone or a protective cell phone case 20 for a cellular phone by a suitable adhesive applied between the rear wall of the cellular phone carrier cap 10 and a back surface of the protective case 20 or cellular phone.

An opening is defined along a side edge of the front wall of the main body 12 providing access to the interior chamber 18.

A closure 14 is attached to the main body 12 via a hinge 16. In the non-limiting embodiment shown, the hinge 16 may include a plurality of interlocking hinge elements 16 dimensioned for a snap fit attachment. As will be appreciated, other hinge arrangements may also be utilized.

A release tab 17 protrudes from an edge of the closure 14 opposite the hinge 16. The release tab 17 is adapted for cooperative engagement with a latch tab 19 protruding from the rear wall of the main body 12. As will be appreciated the latch tab 19 may also be formed as a recess to receive the release tab 17 and retain the closure 14 in the closed condition. The release tab 17 and the latch tab 19 may be of a snap fit cooperative engagement or other suitable configuration to retain the closure 14 against the opening of the main body 12, and released to allow opening of the closure 14 to provide access to the interior chamber 18.

The interior chamber 18 may be dimensioned to carry various articles. In the non-limiting embodiment shown, the interior chamber is dimensioned to carry a reusable bag 22. The reusable bag 22 may be folded and stowed within the interior chamber 18. The reusable bag 22 may be provided with loops or hand holds 24 to facilitate carry the reusable bag 22 when items are placed therein.

In certain embodiments, the main body 12 may be dimensioned to fit any cell phone case, and or cell phone, that is, it is manufactured to fit the specification of the variety of cell phones on the market.

The cell phone carrier cap is preferably molded as part of the cell phone case body. In some embodiments, the bag carrier cap can also be manufactured as a separate accessory. In these embodiments, an adhesive or adhesive strip can be utilized to affix the carrier cap to a surface of any cell phone case.

A reusable bag, such as shown in reference to FIG. 7 is sized to fit inside of the cell phone carrier cap. The reusable bag is sized to fit inside of the cell phone cap, when in a folded, stowed condition. To assist the consumer when folding the bag and inserting it into the cap, the bag will have two flat plastic pieces affixed to it to serve as the ‘top’ and ‘bottom’ of the bag when folded.

The cell phone bag carrier cap may have a hinged closure mechanism that will serve as a seal to contain the reusable bag, when not in use. As indicated, that bag carrier cap may be molded as a separate item that will have an adhesive backing so it can be affixed to any current cell phone or case.

In other embodiments, the cell phone case 20 and cellular phone carrier cap 10 may be molded as a unitary piece, in a thin yet durable thermoplastic or composite material. The cell phone case 20 and carrier cap 10 may be made in a variety of sizes to fit the most popular cell phone cases on the market. The cellular phone carrier cap 10 can also be molded as a stand-alone accessory with a similar thin, yet durable plastic.

The reusable bag 22 may be fabricated from a thin, lightweight material such as ‘rip-stop’ nylon, or the like. The reusable bag 22 may include a handle 24 cut into the top end of the bag. In some embodiments, the reusable bag 22 will also have a plurality of thin rigid or semi-rigid guide pieces that may permanently affixed to the bag to aid the consumer in folding the reusable bag 22 to the proper dimensions for inserting the reusable bag 22 into the cellular phone carrier cap 10. In other embodiments, the bag may have guide indicia (not shown) to provide a reference line for folding the reusable bag 22 so that when folded it is dimensioned to be received within the interior chamber 18.

In use, a person would use the cellular phone carrier cap 10 of the present invention by replacing their existing cell phone case 20 with the cell phone case 20 with integrally formed cellular phone carrier cap 10. Alternatively, a person could use the carrier cap 10 device and affix it to their existing cell phone case 20.

Alternatively, the cell phone case cap 10 may be employed as a holding bin for items that may fit in it, such as a driver's license, a credit card, money, etc . . . .

It should be understood, of course, that the foregoing relates to exemplary embodiments of the invention and that modifications may be made without departing from the spirit and scope of the invention as set forth in the following claims.

What is claimed is:

1. A carrier cap for a cellular phone device, comprising:
a main body having at least one sidewall defining an interior cavity, the main body dimensioned to be received on one or more of a back surface of the cellular phone device or a case for the cellular phone device;
an opening to the interior cavity defined along a side of the main body; and
a closure hingedly attached to the main body, the closure operable between a closed position covering the opening, and an open position providing access to the interior cavity via the opening.

2. The carrier cap of claim 1, further comprising:
a plurality of hinge elements defined along an edge of a front sidewall, along the opening to the interior cavity; and
a plurality of cooperating hinge elements defined along a top end of the closure, wherein the plurality of hinge elements and the plurality of cooperating hinge elements are joined in a snap fit configuration.

3. The carrier cap of claim 2, further comprising:
a release tab protruding from an edge of the closure along an edge of the closure opposite the cooperating hinge elements, the release tab operable to release the closure from the closed position.

4. The carrier cap of claim 3, further comprising:
a latch tab protrudes from an edge surface of the main body opposite the plurality of hinge elements.

5. The carrier cap of claim 3, further comprising:
a latch tab formed as a recess in an edge surface of the main body, opposite the plurality of hinge elements.

6. The carrier cap of claim 1, wherein the interior cavity is dimensioned to receive a folded reusable bag.

7. The carrier cap of claim 6, further comprising:
a folded reusable bag, received within the interior cavity.

8. The carrier cap of claim 1, further comprising:
an adhesive layer formed on an outer surface of the back sidewall.

9. A cellular phone case with a carrier cap, comprising:
a cellular phone case having a body dimensioned to receive a cellular phone device, the cellular phone case having a back surface;
a carrier cap main body having at least one sidewall defining an interior cavity, the carrier cap main body dimensioned to be received on the back surface of the cellular phone case;
an opening to the interior cavity defined along a side of the carrier cap main body; and
a closure hingedly attached to the carrier cap main body, the closure operable between a closed position covering the opening, and an open position providing access to the interior cavity via the opening.

10. The cellular phone case of claim 9, further comprising:
a plurality of hinge elements defined along an edge of a front sidewall of the carrier cap main body, along the opening to the interior cavity; and
a plurality of cooperating hinge elements defined along a top end of the closure, wherein the plurality of hinge elements and the plurality of cooperating hinge elements are joined in a snap fit configuration.

11. The cellular phone case of claim 10, further comprising:
a release tab protruding from an edge of the closure along an edge of the closure opposite the cooperating hinge elements, the release tab operable to release the closure from the closed position.

12. The cellular phone case of claim 11, further comprising:
a latch tab protruding from an edge surface of the carrier cap main body opposite the plurality of hinge elements.

13. The cellular phone case of claim 11, further comprising:
a latch tab formed as a recess in an edge surface of the carrier cap main body, opposite the plurality of hinge elements.

14. The cellular phone case of claim 9, wherein the interior cavity is dimensioned to receive a folded reusable bag.

15. The cellular phone case of claim 14, further comprising:
a folded reusable bag, received within the interior cavity.

16. The cellular phone case of claim 9, further comprising:
an adhesive layer joining the carrier cap main body to the cellular phone case.

17. The cellular phone case of claim 9, wherein the carrier cap main body is integrally formed with the cellular phone case.
